(19) United States
(12) Patent Application Publication
(10) Pub. No.: US 2026/0328958 A1
(43) Pub. Date: Oct. 22, 2026

(54) Detecting Faults in Subsurface Formations

(71) Applicant: Saudi Arabian Oil Company, Dhahran (SA)

(72) Inventors: Dima M. Alalharith, Dammam (SA); Jinsong Wang, Dhahran (SA); Saleh Al-Dossary, Dammam (SA)

(21) Appl. No.: 19/186,270

(22) Filed: Apr. 22, 2025

(51) Int. Cl. G01V 1/30; G01V 1/36

(52) U.S. Cl. CPC G01V 1/301; G01V 1/364; G01V 2210/324; G01V 2210/6161; G01V 2210/642

(57) ABSTRACT

A computer implemented method that enables three dimensional directional fault detection in post-stack seismic data is described. The method includes determining dip angles representing faults in data slices and decomposing the data slice into a frequency domain. A phase of the data slice is modified in the frequency domain and a gradient field of the phase is extracted to detect edges present in the data slice in the frequency domain. Detected edges are transformed to generate an edge map corresponding to the data slice, and edge maps corresponding to inline, crossline, and timeline data slices are merged to generate a representative view of the seismic section.

### TECHNICAL FIELD

This specification generally relates to hydrocarbon exploration, drilling, and production, and more particularly to detecting faults in subsurface formations.

### BACKGROUND

In reflection seismology, geologists and geophysicists perform seismic surveys to map and interpret sedimentary facies and other geologic features for applications such as, for example, identification of potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

### SUMMARY

This specification describes fault detection using an edge detection algorithm inspired by physics of electromagnetic diffraction and dispersion. An edge detection algorithm based on the physics of electromagnetic diffraction and dispersion. The physics-based edge detection algorithm is applied to three dimensional (3D) seismic data, where a seismic volume is processed in parallel in multiple directions. The 3D physics-based edge detection algorithm executes on data slices of a seismic volume in parallel, enabling a global orientation approach that considers the overall orientation and structure of geological features across an entire seismic volume. An original image is embedded into a set of feature maps that can be used for fault detection and classification. The 3D physics-based edge detection algorithm performs exceptionally well as an edge and texture extractor in low light level and low contrast images.

The approach disclosed in this specification can be used to locate areas within a reservoir that are dense with fractures and determine the orientation of these fractures. In examples, the disclosed systems and methods isolate faults in user-specified directions for the characterization of reservoirs. Specific dominant faults or clusters of faults are filtered by angle, which is beneficial to the interpretation of reservoirs and saves time spent on traditional fault picking. The systems and method described herein enable consistent results instead of relying on an interpreter's experience and judgment, as different interpreters may produce varying results, leading to inconsistencies in seismic interpretation. The seismic data is often extensive and high-dimensional, making it challenging to manually pick faults across large datasets. This can lead to incomplete analysis and missed faults. The approach described herein enables efficient processing of seismic datasets with a complete analysis that detects even subtle faults. Moreover, the faults are detected and isolated in specific directions.

The gradient phase transform of the 3D physics-based edge detection algorithm enables accurate detection of faults by enhancing the resolution of seismic images of a seismic volume. Accurate detection of faults reduces the time and effort required for manual interpretation of seismic data. This efficiency can translate into faster decision-making and reduced operational costs. Knowing the precise locations of faults enables efficient planning or revision of drilling operations. For example, drilling plans are revised to avoid drilling a well that enters one or more fault zones (e.g., areas with faults). Avoiding fault zones during drilling prevents drilling complications and ensures safer and more efficient drilling operations. In examples, when detected faults are located near existing wells or infrastructure, structural reinforcement of wells or infrastructure. For example, well casings are reinforced, the placement of rigs is adjusted, and pipelines and other equipment are secured. Pipelines are secured to withstand potential ground movements using flexible joints, reinforced concrete foundations, vibration-resistant materials, or any combinations thereof. Additionally, in some examples detected faults are used to locate the installation of seismic isolation systems that decouple oil and gas equipment and infrastructure from ground motion, reducing the impact of seismic activity at detected faults on the infrastructure.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic view illustrating hydrocarbon exploration and production activities is a subsurface formation.

FIG. 2A illustrates a seismic volume representing at least a portion of the subsurface formation.

FIG. 2B illustrates directional organization of seismic data represented by a seismic volume.

FIG. 3 is a workflow enabled by 3D directional fault detection in post-stack seismic data using gradient phase transform in the frequency domain.

FIG. 4 is a block diagram that illustrates 3D directional fault detection in post-stack seismic data using gradient phase transform in the frequency domain.

FIG. 5 shows inline fault detection on synthetic seismic data according to the present techniques.

FIG. 6 shows crossline fault detection on synthetic seismic data according to the present techniques.

FIG. 7 shows timeline fault detection on synthetic seismic data according to the present techniques.

FIG. 8 shows the 3D physics-based edge detection algorithm applied to seismic data with multiple user specified directions.

FIG. 9 shows the 3D physics-based edge detection algorithm on a real world seismic section.

FIG. 10 is a process flow diagram of a process for 3D directional fault detection in post-stack seismic data using gradient phase transform in the frequency domain.

FIG. 11 illustrates hydrocarbon production operations that include both one or more field operations and one or more computational operations, which exchange information and control exploration for the production of hydrocarbons.

FIG. 12 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes detecting faults in subsurface formations. This approach is based on post-stack seismic data using a gradient phase transform in the frequency domain. A 3D physics-based edge detection algorithm processes a seismic volume in parallel, in multiple directions. The 3D physics-based edge detection algorithm executes on data slices of a seismic volume in parallel, enabling a global orientation approach that considers the overall orientation and structure of geological features across an entire seismic volume. The present systems and methods use the full input (e.g., full seismic volume) in a global approach that includes scales and spatial frequencies at once in each two dimensional (2D) slice of the seismic volume. Features are transformed into the frequency domain and the physics-based edge detection algorithm parameters and kernel is used to detect the edges of at varying frequencies and scales. A center frequency (mu_1) and mu_2 then control the spatial frequencies to be focused on. The strength parameters and sigma then control the scale of the edges. The edges are computed using a rotation kernel that is generated based on the orientations in the frequency domain. In some implementations, these orientations are provided by a user.

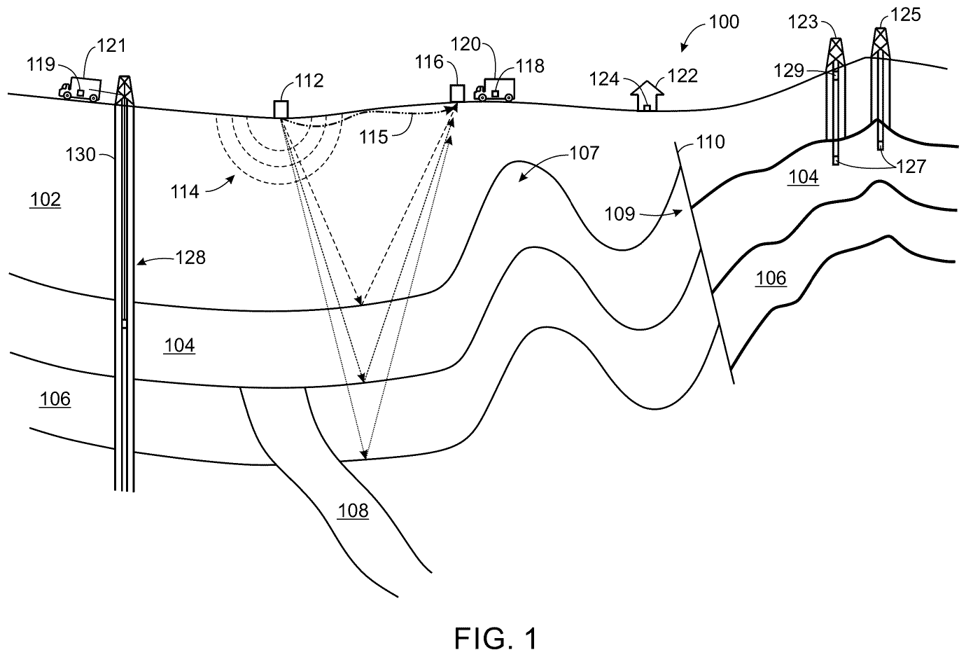

FIG. 1 is a schematic view illustrating hydrocarbon exploration and production activities in a subsurface formation 100. In examples, the subsurface formation 100 is surveyed to obtain seismic data. For example, seismic data is captured along a seismic trace. The seismic traces are grouped based on their common midpoint and corrected for differences in travel time due to varying source-receiver distances. The corrected traces are summed to generate a stacked seismic section.

The subsurface formation 100 includes a layer of impermeable cap rocks 102 at the surface. Facies underlying the impermeable cap rocks 102 include layers 104, 106, and 108. A fault line 110 extends across the layer 104 and the layer 106.

Oil and gas tend to rise through permeable reservoir rock until further upward migration is blocked, for example, by the layer of impermeable cap rock 102. Seismic surveys attempt to identify locations where interaction between layers of the subsurface formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1, the source or sources 112 are typically a line or an array of sources 112. The generated seismic waves include seismic body waves 114 that travel into the ground and seismic surface waves 115 travel along the ground surface and diminish as they get further from the surface.

The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic body waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

The seismic surface waves 115 travel more slowly than seismic body waves 114. Analysis of the time it takes seismic surface waves 115 to travel from source to sensor can provide information about near surface features.

In some implementations, a wellbore 130 that has been drilled in the subsurface formation 100 is logged in a well logging operation 128. The wellbore 130 extends downhole from a wellhead 132. The wellbore 130 is a vertical wellbore but well logging can also be performed in other wellbores, for example, slanted or horizontal wellbores. In the well logging operation 128, the wellbore 130 penetrates through three layers 102, 104, and 106 of a subsurface formation 100. A control truck 121 lowers a logging tool 134 down the wellbore 130 on a wireline 136.

The logging tool 134 is string of one or more instruments with sensors operable to measure geophysical properties of the subsurface formation 100. For example, logging tools can include resistivity logs, borehole image logs, porosity logs, density logs, or sonic logs.

As the logging tool 134 travels downhole, measurements of formations properties are recorded to generate a well log. In the illustrated operation, the data are recorded at the control truck 121 in real-time. Real-time data are recorded directly against measured cable depth. In some well-logging operations, the data is recorded at the logging tool 134 and downloaded later. In this approach, the downhole data and depth data are both recorded against time. The two data sets are then merged using the common time base to create an instrument response versus depth log.

In the well logging operation 128, the well logging is performed on a wellbore 110 that has already been drilled. In some operations, well logging is performed in the form of logging while drilling techniques. In these techniques, the sensors are integrated into the drill string and the measurements are made in real-time, during drilling rather than using sensors lowered into a well after drilling.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems that provide additional information about the subsurface formation. For example, the control center 122 can receive data from a computer 119 associated with a well logging unit 121.

The computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

The computer systems 124 in the control center 122 can be configured to analyze, model, control, optimize, or perform management tasks of field operations associated with development and production of resources such as oil and gas from the subsurface formation 100. For example, an injection well 123 and a production well 125 extend into layer 104 of the subsurface formation 100. Based on data gathered by the exploratory field operations, the computer systems 124 can generate models such as a reservoir model for portions of the subsurface formation 100. These models can simulate the effects of production field operations (e.g., injecting water or carbon dioxide through the injection well 123 to increase the production of hydrocarbons through the production well 125). The simulations can be used to plan and, in some instances, control field operations (e.g., the operation of pumps associated with the injection well 123 and the production well 125).

In some implementations, results generated by the computer systems 124 may be displayed for user viewing using local or remote monitors or other display units. One approach to analyzing seismic data is to associate the data with portions of a seismic volume representing the subsurface formation 100. The seismic volume can also display results of the analysis of the seismic data associated with the seismic survey.

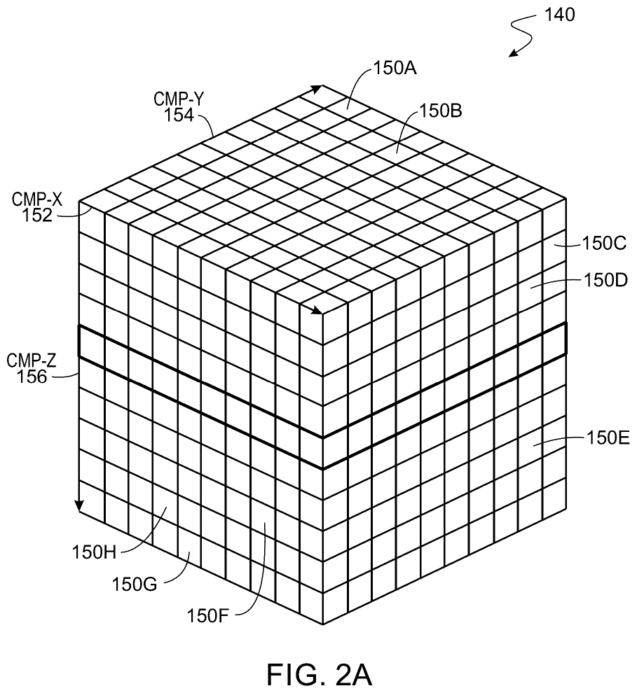

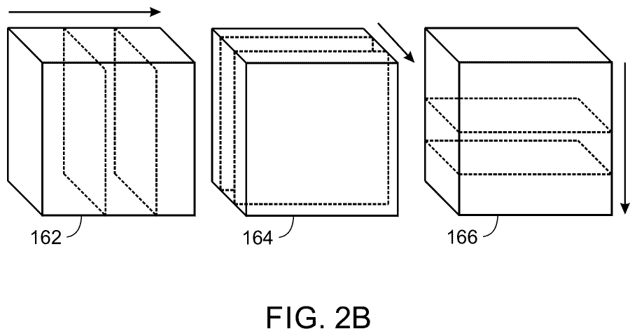

FIG. 2A illustrates a seismic volume 140 representing at least a portion of the subsurface formation 100. The seismic volume 140 is composed of a number of voxels 150A-H. A voxel is a volume element and each voxel corresponds, for example, with seismic data captured along a seismic trace. The cubic volume C is composed along intersection axes of offset spacing times based on a Delta-X spacing 152, a Delta-Y offset spacing 154, and a Delta-Z offset spacing 156. Within each voxel 150A-H, statistical analysis can be performed on data assigned to respective voxels to determine, for example, multimodal distributions of travel times and derive robust travel time estimates (according to mean, median, mode, standard deviation, kurtosis, and other suitable statistical accuracy analytical measures) related to azimuthal sectors allocated to the respective voxels 150A-H.

FIG. 2B illustrates directional organization of seismic data represented by seismic volume 140. In some implementations, seismic data is processed along inline (X-axis), crossline (Y-axis), and timeline (Z-axis) directions. At reference number 162, processing along the inline direction is shown. The inline direction corresponds to the direction along which the seismic data is acquired. In examples, the inline direction is aligned with receiver lines (e.g., sensors 116 of FIG. 1) configured in a predetermined pattern to capture seismic waves (e.g., seismic waves 114 of FIG. 1) generated by a seismic source (e.g., seismic source 112 of FIG. 1) during seismic surveying. Similarly, at reference number 164, processing along the crossline direction is shown. The crossline direction corresponds to the direction that is perpendicular to the inline direction. In examples, the inline direction is perpendicular to the receiver lines. At reference number 166, processing along the timeline direction is shown. The timeline direction corresponds to the direction that corresponds to different depths of the subsurface. Seismic data is captured at the different depths at constant time intervals.

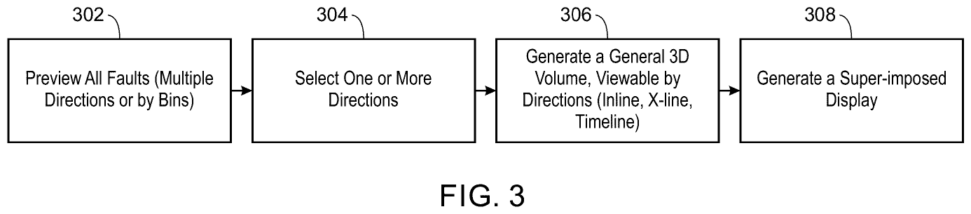

FIG. 3 is a workflow 300 enabled by 3D directional fault detection in post-stack seismic data using gradient phase transform in the frequency domain.

At block 302, a preview of faults in a seismic volume is generated. The preview can be generated according to multiple directions or by bins. In some implementations, dip angles are estimated based on regional geological settings (tectonics) or other reservoir properties. The estimated dip angles are specified to generate the edge features/faults according to multiple directions or by bins.

At block 304, one or more directions for fault detection using a physics-based edge detection algorithm are identified. The directions for fault detection include, for example, unidirectional, multidirectional, and omnidirectional. In unidirectional fault detection, a physics-based edge detection algorithm is used to detect certain faults at a specific angle. In multidirectional fault detection, a physics-based edge detection algorithm is used to detect faults at multiple angles. In omnidirectional fault detection, a physics-based edge detection algorithm is used to detect edges with binning per each edge orientation. In some implementations, the physics-based edge detection algorithm is applied in unidirectional, multidirectional, and omnidirectional processing based on determined or known dip angles.

At block 306, a general 3D volume is created from the physics-based edge detection algorithm output generated according to one or more directions. In examples, the 3D volume is viewable according to inline, crossline, and timeline directions.

At block 308, a super-imposed image may be generated. In examples, the physics-based edge detection algorithm output includes edges detected in inline, crossline, and timeline directions. The detected edges can be super-imposed onto an original seismic image from the seismic volume to create the super-imposed image. The final edge image can be viewed with or without the original seismic image. The super-imposed image offers users the advantage to delineate faults on the seismic volume.

Accordingly, the present systems and methods use estimated dip angles of a potential fault zone to isolate and consequently extract faults from a post-stack seismic volume using a 3D physics-based edge detection algorithm. Traditional fault detection algorithms generate tens of thousands of fault planes and leave it to an interpreter to manually differentiate and highlight the dominant faults. However, seismic data often contain many discontinuities across multiple possible fault planes, which in turn causes challenging seismic interpretation and fault picking. The present systems and methods isolate the desired faults in user-specified directions for the characterization of reservoirs using a gradient phase transform, enabling the identification and extraction of faults at specified directions. In some embodiments, faults are isolated by iteratively executing the 3D physics-based edge detection algorithm. In a first iteration, faults are detected by the 3D physics-based edge detection algorithm according to omnidirectional fault detection. In subsequent iterations, selected directions are obtained by the 3D physics-based edge detection algorithm and used to isolate faults. In examples, a user specifies the selected directions by briefly reviewing a final edge map rendered based on the omnidirectional fault detection from the first iteration.

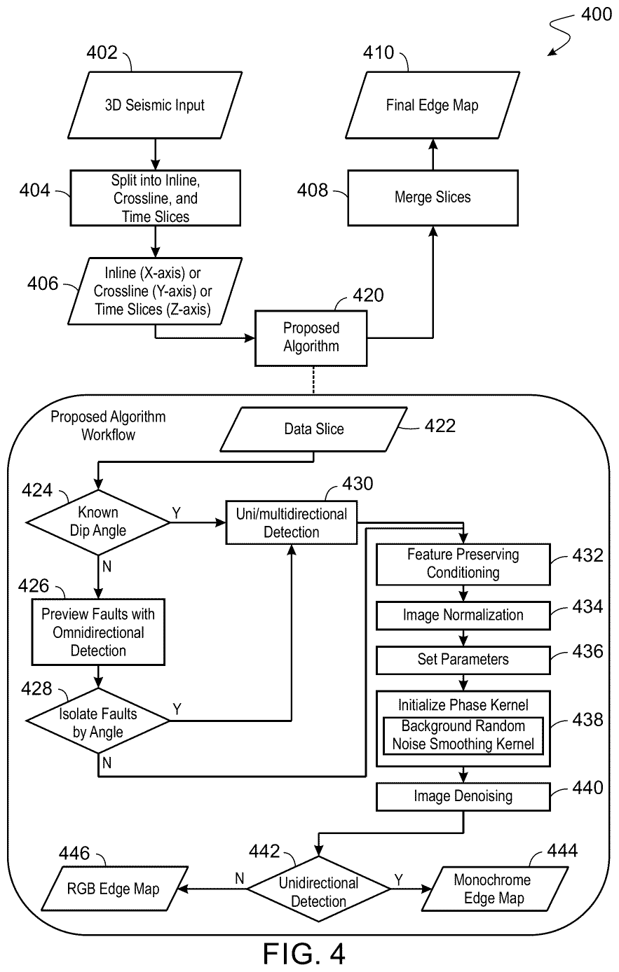

FIG. 4 is a block diagram that illustrates 3D directional fault detection in post-stack seismic data using gradient phase transform in the frequency domain. 3D seismic data input is obtained at block 402. 3D seismic data is rich with information, with each dimension representing timeline (depth), inline, and cross-line directions. Therefore, the seismic data is converted to a 3D matrix with each voxel representing a specific point in 3D space. Each input image's pixel values are normalized prior to the application of the physics-based edge detection algorithm. Image normalization is used to adjust a contrast of an image so that the intensity values of the image span the entire intensity range. Furthermore, this larger span of the intensity values enables sharper differences between dark and bright regions.

The 3D seismic data input is split into inline, crossline, and timeline data slices at block 404. The physics-based edge detection algorithm has been modified and expanded to process 3D seismic data in three directions: inline, crossline, and timeline separately (FIG. 1). This ensures edges of the seismic volume, and consequently the geological features of the subsurface, are captured accurately.

At block 406, a direction for data processing using the gradient phase transform is selected. With the exponential growth of the size of seismic data collected in seismic surveys, the 3D physics-based edge detection algorithm is adapted to enable a parallel implementation for large-scale processing. In examples, the physics-based edge detection algorithm is modified to adapt to GPU parallel computation, leading to accelerated image processing and better scalability.

The physics-based edge detection algorithm is applied to the directional seismic data at block 420. The physics-based edge detection algorithm computes a feature set comprising edges at different spatial frequencies, at different orientations, and at different scales. Mathematically, the physics-based edge detection algorithm can be described as follows:

[symbol]

{Eᵢ[x,y]}= [symbol] {Eᵢ[x,y]}

Where [symbol] · [symbol] is the angle operator and [symbol] { } is the birefringent stretch operator:

[symbol]

{Eᵢ[x, y]}=IFFT²{\acute{K}[u, v, θ]·L[u, v]·FFT²{FPC{Eᵢ[x, y]}}}
and \acute{K}[u, v, θ] is the physics-based edge detection algorithm kernel where u, v are two-dimensional frequency variables with a steerable angle variable θ:

u′=u·cos(θ)+v·sin(θ)

v′=−u·sin(θ)+v·cos(θ)

wherein the variables are as follows:

| | |
|---|---|
| Eᵢ[x, y] | Input image |
| IFFT² | Two-dimensional Inverse Fast Fourier |
| | Transform |
| [u, v] | Two-dimensional frequency variables |
| \acute{K}[u, v, θ] | Physics-based edge detection algorithm |
| | kernel |
| L[u, v] | Background random noise smoothing |
| | kernel |
| FFT² | Two-dimensional Fast Fourier Transform |
| FPC | Feature Preserving Conditioning |

In the above equations, Eᵢ[x, y] is the input image, x and y are the spatial variables, FFT² is the two-dimensional Fast Fourier Transform, IFFT² is the two-dimensional Inverse Fast Fourier Transform, FPC is a feature preserving conditioning algorithm and u and v are frequency variables. The \acute{K}[u, v, θ] function is called the physics-based edge detection algorithm kernel and it is designed to compute semantic information from an image at different orientations and frequencies. It consists of a phase filter which is a function of frequency variable u and v and a steerable angle variable θ which controls the directionality of the response. The L[u, v] function is a smoothening kernel, which removes noise artifacts from the FPC contrast enhancement step. Both the physics-based edge detection algorithm kernel and the smoothening kernel are implemented in the frequency domain.

Referring again to FIG. 4, the physics-based edge detection algorithm workflow begins at block 422 on a 2D data slice of the 3D volume. For each data slice, fault detection can occur in multiple fault detection modes, such as unidirectional, multidirectional, and omnidirectional. In unidirectional fault detection, the physics-based edge detection algorithm workflow detects certain faults at a specific angle. In multidirectional fault detection, the physics-based edge detection algorithm workflow detects faults at multiple angles. In omnidirectional fault detection, the physics-based edge detection algorithm workflow detects edges with binning per each edge orientation.

Omnidirectional fault detection is applied to data slices when a corresponding dip angle is unknown. Unidirectional or multidirectional fault detection is applied to data slices based on known dip angles. Dip angles may be known based on user expertise or known features of the subsurface. In some implementations, a user can specify certain angles as input without previewing them through experience. For example, the user may know faults are rich in certain angle(s) in this region from other resources, but further confirmation or investigation in seismic is required. In this case, the user can directly specify that angle as input. The output may or may not contain faults but if faults exist, they are detected using the specified angle. Accordingly, the user can either preview the data and focus on extracting faults in certain directions or choose any angle of interest, but the output may or may not contain faults.

At block 424, it is determined if the dip angle is known. If the existence of dip faults in the data slice is unknown, dip angles are scanned in the full range of orientations (omnidirectional) to detect edges by binning at edge orientation. Specific angles are determined with respect to each bin to further investigate. If dip angles are known based on regional geological settings (tectonics) or other reservoir properties, the known dip angles are specified to generate the edge features/faults. In some implementations, a user specifies the known dip angles. Referring again to FIG. 4, if the dip angle is not known, process flow continues to block 426. If the dip angle is known, process flow continues to block 430.

At block 426, faults are previewed with omnidirectional detection. In examples, a bin-based general orientation output of edges in the data slice is generated (orientations ranging from 0-360 degrees), and the user can use an image display tool to preview which direction has more dominant edges/faults. In omnidirectional detection, a magnitude and direction of the gradient of the image is computed. The gradient directions are divided into bins. For a full 360-degree range, the gradient directions are typically divided into a set number of bins (e.g., 10 bins, each covering 36 angles with a default directional interval of 1 degree). The edge in each bin will be combined and computed. Each pixel's gradient direction is assigned to the nearest bin. The binned data slice is embedded into at least one feature map by transforming the data slice into a complex function including both real and imaginary components. A Fourier transform is applied to the feature map to decompose the image into its frequency components. The Fourier transform coverts the data slice from the spatial domain to the frequency domain, which enables analysis of the image's frequency components, which correspond to different spatial frequencies. The image is decomposed into multiple sub-bands, each representing a specific range of spatial frequencies, where each sub-band captures features at different scales. Within each sub-band, the image is further analyzed to detect edges at various orientations. The resulting feature maps from the sub-bands and orientation analysis highlight edges and other significant features. These maps represent the image's structure at different spatial frequencies, orientations, and scales, creating a comprehensive feature set. This enables a preview of the spatial frequencies and orientations of edges corresponding to each bin.

At block 428, it is determined if the faults are isolated by dip angle. Based on the preview of the spatial frequencies and orientations of edges corresponding to each bin (which includes edges in possible orientations), determined faults can be targeted in a certain direction, for example at 45 degrees. In this example, the user can specify 45 degrees as input to the physics-based edge detection algorithm workflow and this will generate an output of all edges/faults at this 45-degree dip direction. In this example, any edges and faults in other directions will be ignored. At this stage, the user could also decide to compute faults in multiple angles. For example, in addition to 45 degrees, the user can also include 90-degree edges, so the output will be edges from both 45 and 90 degrees. Accordingly, if the faults are isolated by dip angle, process flow continues to block 430. If the faults are not isolated by dip angle, process flow continues to block 432.

At block 430, uni/multidirectional detection is performed. Similar to block 426, the data slice is embedded into at least one feature map by transforming the data slice into a complex function including both real and imaginary components according to the known dip angle. The known dip angle may be captured from user inputs or other known information about the formation. A Fourier transform is applied to the feature map to decompose the image into its frequency components. This generates edges at varying spatial frequencies, orientations, and scales according to the known dip angles.

At block 432, feature preserving conditioning is performed. Seismic data conditioning is used to improve and preserve fault edges. In some implementations, seismic data conditioning includes, but is not limited to noise reduction, spectral balancing, amplitude versus offset conditioning, edge-preserving smoothing, or any combinations thereof. Spectral balancing includes adjusting the frequency components of the seismic data to enhance the low-frequency content and improving the overall quality of the data while preserving important features. Amplitude versus offset conditioning ensures that variations in amplitude are due to reflection-coefficient changes and not processing artifacts by mitigating multiple, random, and coherent noise, correcting seismic velocities, and addressing frequency distortions. Edge-preserving smoothing is used to reduce noise while preserving edges to ensures that important geological features are maintained in the conditioned data.

At block 434, image normalization is performed. In some implementations, each feature set is normalized by scaling raw seismic amplitudes to the range of 0-255 (floating numbers). In examples, the image intensity values are adjusted to a standard range to ensure consistency.

At block 436, physics-based edge detection algorithm parameters are set. In some implementations, the physics-based edge detection algorithm parameters are initialized, and a physics-based edge detection algorithm kernel constructed. The below parameters control the behavior and performance of the physics-based edge detection algorithm:

TABLE 1

| Parameter | Type | Description |
|---|---|---|
| num_bins | Int | Number of different directions of edge to be extracted |
| directs | Int/Array | Different directions of edge to be extracted |
| mu_1 | Float | Center frequency of a normal distributed passband filter |
| | | φ1 |
| mu_2 | Float | Center frequency of log-normal distributed passband |
| | | filter φ2 |
| sigma_1 | Float | Standard deviation of normal distributed passband filter |
| | | φ1 |
| sigma_2 | Float | Standard deviation of log-normal distributed passband |
| | | filter φ2 |
| S1 | Float | Phase strength of φ1 |
| S2 | Float | Phase strength of φ2 |
| sigma_LPF | Float | Standard deviation of the low pass filter |
| thresh_min | Float | Minimum threshold, we keep features < thresh_min |
| thresh_max | Float | Maximum threshold, we keep features > thresh_max |
| morph_flag | Boolean | Whether apply morphological operation |
| out_mode | Boolean | Whether to output in mono or RGB |

The physics-based edge detection algorithm is based on principles from physics, particularly those related to optics and electromagnetic wave propagation. In a birefringent optical medium, the dielectric constant of the medium and its refractive index is a function of spatial frequency and the polarization in the transverse plane. To understand the analogy between the physics-based edge detection algorithm approach and electromagnetic propagation equations, let's consider an optical field with two linearly orthogonal polarizations propagating through a medium. The Fourier content of the incoming signal is denoted as follows:

[symbol]

(u, v; z)=FFT{ [symbol] (x, y; z)}

and can be decomposed into the two orthogonal polarizations as follows:

[symbol]

(z)= [symbol] (z)+ [symbol] (z)
where FFT{ } is the fast Fourier transform over the transversal coordinates and (u, v) are spatial frequency variables. As the propogation constant

$$β = \frac{2 π n}{λ}$$

is a function of refractive index, the two orthogonal polarizations [symbol] (z) and [symbol] (z) will have different propagation constants and hence, a phase difference at the output given by the following equation:

$$Δϕ = {ϕ}_{x} - {ϕ}_{y} = Δβ = \frac{{ω}_{m}}{c} \vert {n}_{x} - {n}_{y} \vert$$

By controlling the value of nₓ and n_{y}, as well the dependence of refractive index on frequency nₓ(ω) and n_{y(ω)} coherent detection at the output detects a hyper-dimensional feature set from a 2D image that corresponds to edges at user-defined specific orientations and spatial frequencies. For purposes of explanation, in the above definition of the phase a propagation length is set to 1. However, other propagation lengths can be used.

The physics-based edge detection algorithm filter banks are defined by the physics-based edge detection algorithm kernel \tilde{K}[u, v, θ] and are designed to compute semantic information from an image at different orientations and frequencies. The physics-based edge detection algorithm kernel \tilde{K}[u, v, θ] consists of a phase filter which is a function of frequency variable u and v, and a steerable angle variable θ which controls the directionality of the response.

A normal passband filter (M u_1 parameter) and a log normal passband filter (M u_2 parameter) are applied to phase for both directions (u, v). These filter banks can detect features at a particular frequency and/or in a particular direction. Therefore, by selecting a desired direction and/or frequency, a hyper-dimensional feature map can be constructed. The physics-based edge detection algorithm filter can then be designed to detect edges at a particular frequency by controlling the spread of log normal distribution by changing sigma_2 and mu_2.

In examples, the parameters in Table 1 are finetuned to the below values to ensure optimal fault detection results:

TABLE 1

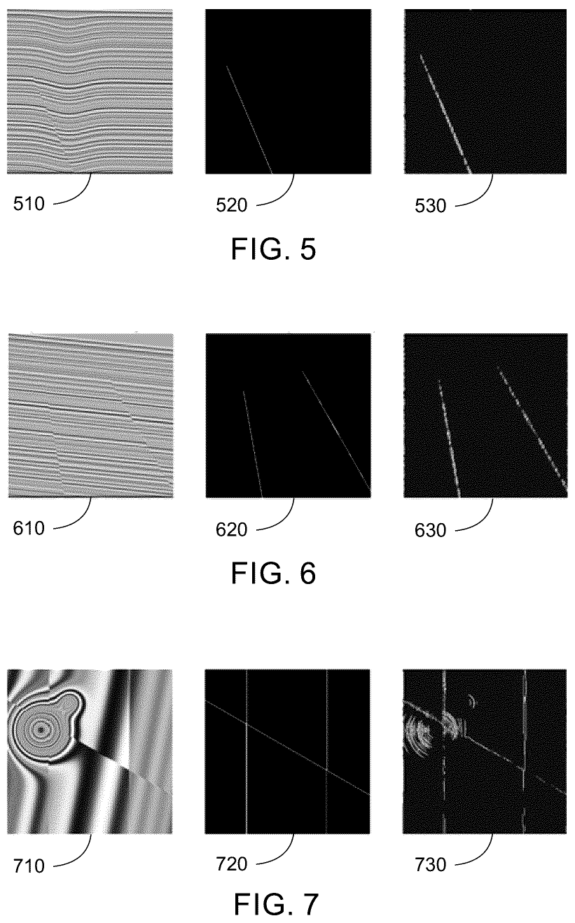

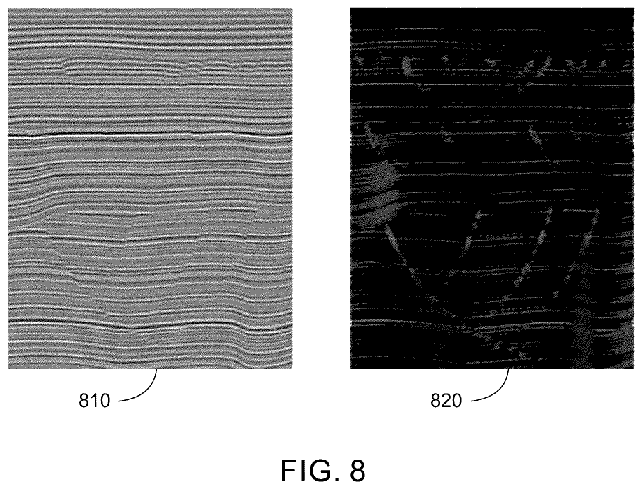

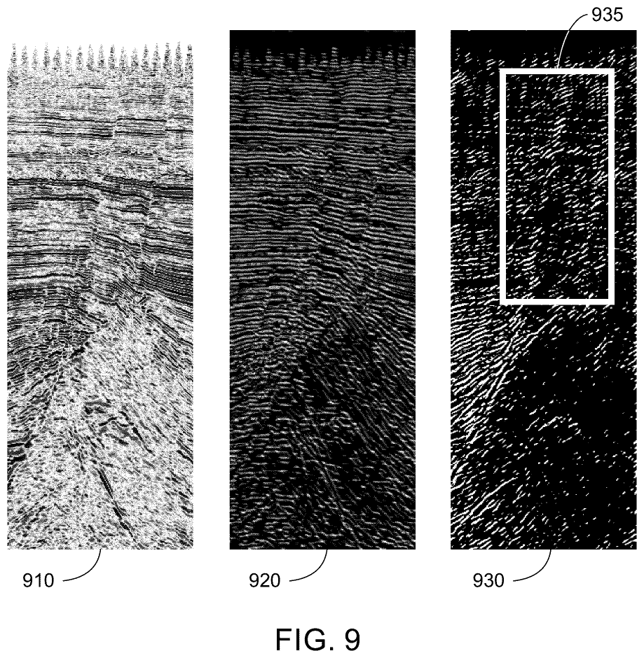

mu_1 = 0
mu_2 = 0.5
sigma_1 = 0.5
sigma_2 = x, y: 0.7, z: 0.5
S1 = 0.8
S2 = 6.8
sigma_LPF = x, y: 0.15, z: 0.35
thresh_min = 0.01
thresh_max = 0.96
morph_flag = 1
num_bins = 150
directs = x: 100, y: 100, z: [90, 135]
out_mode = FIGS. 5, 6, 7: 1, FIG. 8: 2

At block 438, the phase kernel is initialized. A low pass filter is applied to the feature maps to remove random noise and denoise the input image in the FFT domain. The physics-based edge detection algorithm kernel performs phase stretch and gradient-field extraction to detect edges and preserve important features using two filtering of phases in FFT domain to extract features. In some implementations, the phase of the complex function is computed. The phase stretch emulates the propagation of an optical field through a birefringent medium, which affects the phase based on spatial frequency and polarization. The features of the image are preserved by maintaining the integrity of the edges and textures. Additionally, the gradient field of the phase is extracted to highlight edges. Gradient field extraction enables feature preservation as it identifies areas where the image brightness changes abruptly, ensuring that important features like edges are maintained. In examples, initializing the phase kernel includes applying a background random noise smoothing kernel. A spectral phase filter emulates the birefringence and frequency channelized diffractive propagation. Noise is reduced by applying a smoothening kernel in the frequency domain. An inverse FFT 2D is applied to the feature vectors to restore edge images.

At block 440, image denoising is applied to edge images. Accordingly, thresholding and morphological operations are applied to the generated feature vectors in the spatial domain. The morphological operations used for the result are edge thinning using thresholding and isolated pixel removing for each directional response. One of the thinning methods employed is setting the image point value to 0 if value is smaller than the threshold, and 1 if it is larger than the threshold. The final output then embeds the original image into a set of feature maps that select semantic information at different scales, orientations, and spatial frequencies.

At block 442, it is determined if unidirectional detection is performed. In unidirectional detection, the kernel only has one value of rotation, whereas in the multidirectional detection, the phase kernel is a vector containing multiple directional operations. In examples, multidirectional detection is a repetition of unidirectional detection with different angles. The workflow 400 processes the output of the physics-based edge detection algorithm workflow based on the type of detection performed. If unidirectional detection is performed, a monochrome edge map is output for the respective data slice. The monochrome edge map isolates faults in monochrome to highlight faults. If unidirectional detection is not performed (e.g., omni/multidirectional detection is performed), an RGB edge map is output for the respective data slice. The RGB edge map isolates faults in different colors to highlight faults at different orientations. The workflow 400 enables computation and analysis of the edges/faults in three different approaches either by single direction, multiple directions, or all directions.

Accordingly, if unidirectional detection is performed, process flow continues to block 444. If unidirectional detection is not performed, process flow continues to block 446. At block 444, a monochrome edge map is generated. At block 446, an RGB edge map is generated. In examples, with each distinct color in the monochrome edge map or RGB edge map represents an edge oriented in a specific direction. As shown in the finetuned parameters of Table 1, FIGS. 5, 6, and 7 show an example of output generated in a first mode corresponding to a monochrome edge map. FIG. 8 shows output generated in a second mode corresponding to an RGB edge map.

At block 408, the edge maps corresponding to the data slices are merged. Merging slices aggregates the edge maps generated by the physics-based edge detection algorithm workflow. Because the input data is 3D, physics-based edge detection algorithm has been applied on process slices in three directions, x, y, or z. Each direction will have a unique 3D volume emphasizing the edges in the slice plane and merging the three 3D volumes together will offer a better final edge map than any individual volume.

At block 410, a final edge map is generated. The final output can either be the semantic information (edge features/faults) only or the original image embedded with such information. The final edge map can be either a merged RGB edge or a monochrome edge map depending on whether multiple angles or a single angle were supplied. The feature maps can be combined or reconstructed to form a detailed representation of the image, capturing edges and textures across various scales and orientations.

Accordingly, the 3D physics-based edge detection algorithm enables a global orientation approach, where certain dominant direction faults are specified and detected to focus on the target faults. Traditional techniques are limited to computing an amplitude gradient at each pixel within a window resulting in local estimation bias and are highly sensitive to the noise inherently present in seismic data. Traditional edge detection based on edge detection filters such as the Sobel, Canny, and Gaussian filters can involve calculating derivatives of the seismic data, which can amplify high-frequency noise. Further by using local gradients to detect edges, the gradients can be distorted in areas with high noise levels leading to biased estimates of edge locations and orientations. The present systems and methods include a global approach that accurately detects edges in seismic data.

FIG. 5 shows inline fault detection on synthetic seismic data according to the present techniques. At reference number 510, a synthetic seismic section is shown. At reference number 520, the ground truth is shown. At reference number 530, the fault detection result in 100 degree angle across X-axis is shown.

FIG. 6 shows crossline fault detection on synthetic seismic data according to the present techniques. At reference number 610, a synthetic seismic section is shown. At reference number 620, the ground truth is shown. At reference number 630, the fault detection result in 115 degree angle across X-axis is shown.

FIG. 7 shows timeline fault detection on synthetic seismic data according to the present techniques. At reference number 710, a synthetic time slice is shown. At reference number 720, the ground truth is shown. At reference number 730, the fault detection result in 90-135 degree angle across the Z-axis is shown.

As shown in FIG. 5-7, the 3D physics-based edge detection algorithm is applied to synthetic data across all three axes of the seismic volume. At FIG. 5, reference number 530, physics-based edge detection algorithm is applied with a 100-degree angle in the inline direction. The results are strongly consistent with the ground truth at reference number 520. Applying the 3D physics-based edge detection algorithm in the crossline direction (FIG. 6) enables a greater degree of detail, revealing an additional fault. Physics-based edge detection algorithm also performs well when applied in the timeline direction (FIG. 7), despite the presence of some artifacts.

FIG. 8 shows the 3D physics-based edge detection algorithm applied to seismic data with multiple user specified directions. At reference number 810, a segment of a 3D volume capture along the inline direction is shown. In examples, a 3D seismic volume contains mainly reflection energy, where areas with faults will generate different responses. Reflection energy refers to the seismic waves that are reflected from subsurface layers and are recorded to create an image of the underground structures. An inline slice of such a volume largely corresponds to a vertical cross-section of these reflections. The inline slice will show variations in the reflection energy, which helps in identifying different geological layers and structures. Areas with faults appear differently on the inline slice. Faults disrupt the continuity of the geological layers, causing changes in the reflection patterns. These changes can manifest as offsets, discontinuities, or variations in the amplitude of the reflections.

In the example of FIG. 8, the user specified directions are 45°, 90°, and 135°. The output 820 is presented in a Red Green Blue (RGB) format, with each distinct color representing an edge oriented in a specific direction. The 3D physics-based edge detection algorithm performs well by highlighting detected faults in a single merged image as shown by the output 820, providing a clearer, more representative view of the seismic section.

FIG. 9 shows the 3D physics-based edge detection algorithm on a real world seismic section. In this particular case, the algorithm executes on a real seismic section at reference number 910 to preview its edges in all directions. In examples, the seismic section is a visual representation of seismic data collected along a specific receiver lines. The seismic section displays multiple traces, with the location given along the x-axis and either two-way travel time or depth along the y-axis. In examples, seismic sections are derived from 2D seismic profiles or extracted from 3D seismic data volumes.

The 3D physics-based edge detection algorithm segments the edges into its three main orientations as seen in at reference number 920, where each color (red, green, or blue) corresponds to an edges at a particular orientation. By splitting the edge map into its RGB channels, the seismic section can be segmented into three main planes. Each channel (e.g., Red, Green, Blue) can highlight different directions or orientations of planes in the seismic data, enabling identification of geological structures created by the planes. For example, at reference number 930, the blue channel image is shown in monochrome for visibility, which highlights two adjacent faults within the square at reference number 935.

Accordingly, the present systems and methods address the lack of algorithms to detect faults based on their directionality through the use of the 3D physics-based edge detection algorithm. The 3D physics-based edge detection algorithm provides geophysical interpretation with a flexible technique to investigate and examine faults in detail, especially in 3D data. Faults can be viewed in inline, crossline and time slice directions and potentially merge the results to get more comprehensive view of potential faults in 3D. The present systems and techniques enable geoscientists to visualize the faults from any angle, reducing the risk of errors and increasing the accuracy of the fault detection and visualization process. Further, the present systems and techniques eliminates the need to analyze all the faults from a 3D dataset at the same time and instead allows users to concentrate on the most important faults and their directions, saving geoscientists valuable time. Moreover, the present systems and techniques enable a more comprehensive understanding of seismic faults and their relationship to the surrounding faults and fractures, allowing geoscientists to make more informed decisions without interpreter bias.

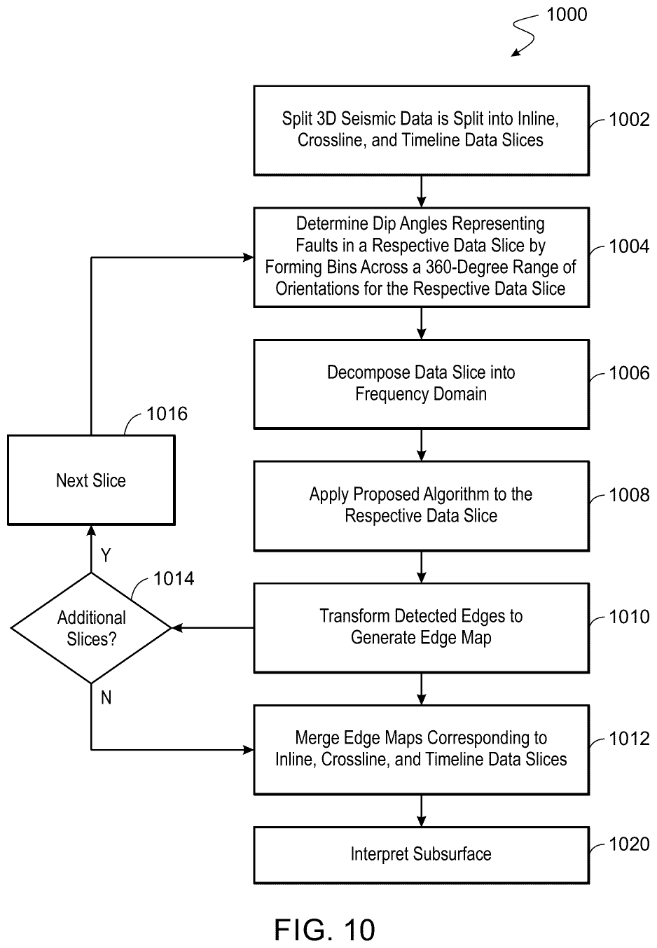

FIG. 10 is a process flow diagram of a process 1000 for 3D directional fault detection in post-stack seismic data using gradient phase transform in the frequency domain.

At optional block 1001, seismic data is generated. For example, a seismic source such as a controlled explosion or a specialized vibrator truck generates seismic waves that travel through the subsurface. The waves are detected by seismic receivers (geophones or hydrophones) placed along the surface or in boreholes. The receivers capture the reflected seismic waves as they bounce back from various layers and features of the subsurface. The captured seismic signals are recorded as a function of time, creating a seismic trace. Each trace represents the seismic response at a specific location along the survey line. The seismic traces are processed to enhance the quality of the seismic traces and remove noise. The processing includes, but is not limited to, filtering, deconvolution, stacking, or any combinations thereof.

At block 1002, 3D seismic data is split into inline, crossline, and timeline data slices.

At block 1004, respective data slices are processed in parallel, where for each data slice, when dip angles are unknown, dip angles representing faults in a data slice are determined by forming bins across a 360 degree range of orientations for the data slice.

At block 1006, the data slice is decomposed into a frequency domain with multiple sub-bands representing a specific range of spatial frequencies, where each sub-band captures features at different scales.

At block 1008, a 3D physics-based edge detection algorithm (e.g., proposed algorithm) is applied to the data slice. In examples, a phase filter is applied to modify a phase of the data slice in the frequency domain to enhance a contrast of edges and a smoothening filter is applied to remove noise artifacts from the data slice in the frequency domain. The phase filter is applied according to determined dip angles or known dip angles. For example, applying the phase filter to modify a phase of the data slice includes using the determined dip angles or known dip angles as the steerable angle variable θ of the phase filter. Additionally, a gradient field of the phase is extracted to detect edges present in the modified data slice in the frequency domain. In some implementations, the known dip angles are specified by a user to focus the phase filter and gradient field extraction to detect edges of a target fault.

At block 1010, the detected edges are transformed to generate an edge map corresponding to the data slice. In some implementations, transforming the detected edges to generate an edge map corresponding to the data slice includes applying an inverse Fourier transform to the modified phase and extracted gradient field to convert the detected edges to a spatial domain.

At block 1014, a determination is made on if additional slices are available for processing. If additional slices are available, a next slice is selected at block 1016. Process flow returns to block 1004 to process the next slices. If additional slices are not available, process flow continues to block 1018. At block 1018, edge maps corresponding to inline, crossline, and timeline data slices are merged. In some implementations, the merged edge maps are used to create a 3D volume with detected edges.

At optional block 1020, the subsurface is interpreted corresponding to the seismic data based on the merged edge maps. In some embodiments, hydrocarbon planning, drilling, or exploration activities are executed based on, at least in part, the general 3D volume including the detected faults. For example, field operations such as forming/drilling a wellbore, hydraulic fracturing, producing through the wellbore, injecting fluids (such as water) through the wellbore, are performed while avoiding instability caused by detected faults. In examples, drilling plans are generated or revised to avoid drilling a well that enters one or more fault zones which prevents drilling complications and ensures safer and more efficient drilling operations. In examples, wells, infrastructure, and equipment are structurally reinforced in response to the detection of faults that impact structural stability of the wells, infrastructure, and equipment. For example, well casings are reinforced (e.g., made thicker or stronger than initially planned), the placement of rigs is adjusted, and pipelines and other equipment are secured to withstand potential ground movements using flexible joints, reinforced concrete foundations, vibration-resistant materials, or any combinations thereof. Seismic isolation systems are constructed in oil and gas fields that decouple equipment and infrastructure from ground motion, reducing the impact of seismic activity at or near detected faults on the infrastructure.

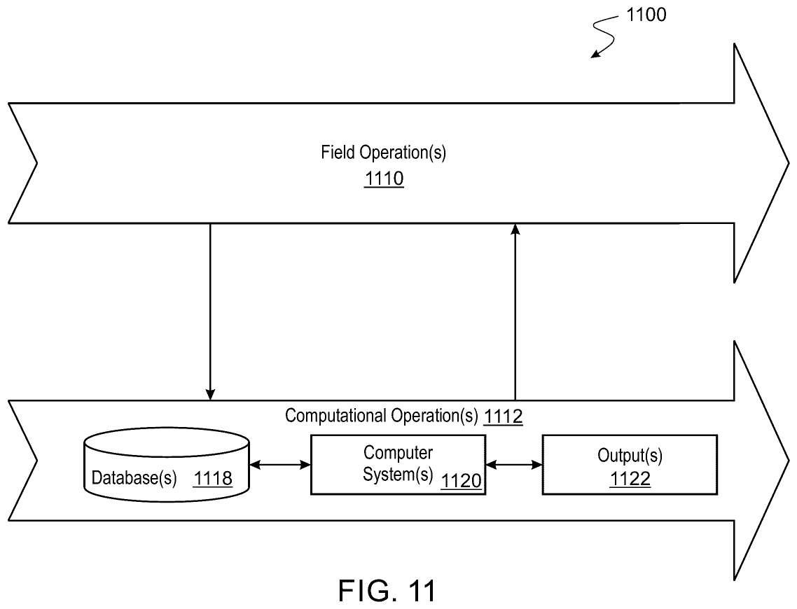

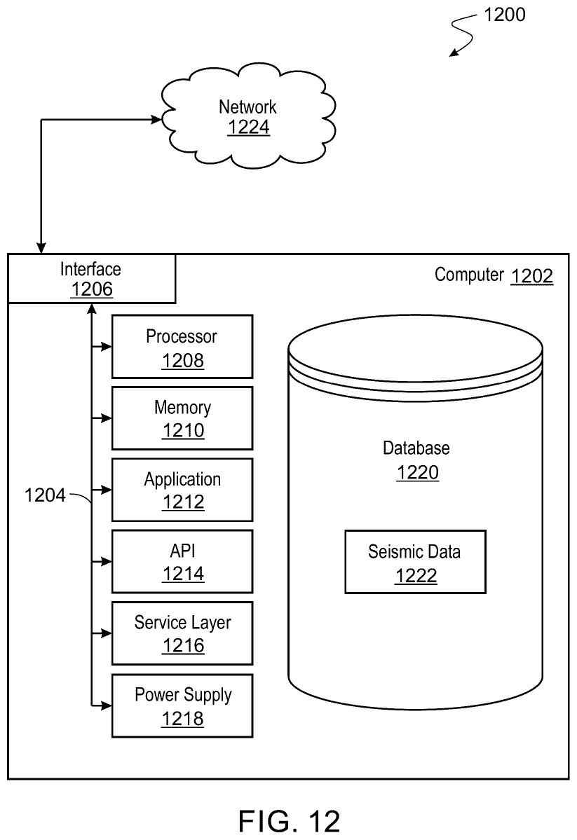

FIG. 11 illustrates hydrocarbon production operations 1100 that include both one or more field operations 1110 and one or more computational operations 1112, which exchange information and control exploration for the production of hydrocarbons. In examples, the computational operations 1112 include 3D directional fault detection in post-stack seismic data using gradient phase transform in the frequency domain. Accordingly, in some implementations, outputs of techniques of the present disclosure can be performed before, during, or in combination with the hydrocarbon production operations 1100, specifically, for example, either as field operations 1110 or computational operations 1112, or both. For example, the merged edge maps can be derived from data captured during a seismic survey to map subsurface features, such as facies and faults. In another example, the merged edge maps guide drilling operations in view of subsurface features identified in the merged edge maps.

Examples of field operations 1110 include forming/drilling a wellbore, hydraulic fracturing, producing through the wellbore, injecting fluids (such as water) through the wellbore, to name a few. In some implementations, methods of the present disclosure can trigger or control the field operations 1110. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1110 and responsively triggering the field operations 1110 including, for example, generating plans and signals that provide feedback to and control physical components of the field operations 1110. Alternatively or in addition, the field operations 1110 can trigger the methods of the present disclosure. For example, implementing physical components (including, for example, hardware, such as sensors) deployed in the field operations 1110 can generate plans and signals that can be provided as input or feedback (or both) to the methods of the present disclosure.

Examples of computational operations 1112 include one or more computer systems 1120 that include one or more processors and computer-readable media (e.g., non-transitory computer-readable media) operatively coupled to the one or more processors to execute computer operations to perform the methods of the present disclosure. The computational operations 1112 can be implemented using one or more databases 1118, which store data received from the field operations 1110 and/or generated internally within the computational operations 1112 (e.g., by implementing the methods of the present disclosure) or both. For example, the one or more computer systems 1120 process inputs from the field operations 1110 to assess conditions in the physical world, the outputs of which are stored in the databases 1118. For example, seismic sensors of the field operations 1110 can be used to perform a seismic survey to map subsurface features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1112 where they are stored in the databases 1118 and analyzed by the one or more computer systems 1120.

In some implementations, one or more outputs 1122 generated by the one or more computer systems 1120 can be provided as feedback/input to the field operations 1110 (either as direct input or stored in the databases 1118). The field operations 1110 can use the feedback/input to control physical components used to perform the field operations 1110 in the real world.

For example, the computational operations 1112 can process the seismic data to generate three-dimensional (3D) maps of the subsurface formation. The computational operations 1112 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1112 to process new information about the formation and control the drilling to adjust to the observed conditions in real-time.

The one or more computer systems 1120 can update the 3D maps of the subsurface formation as information from one exploration well is received and the computational operations 1112 can adjust the location of the next exploration well based on the updated 3D maps. Similarly, the data received from production operations can be used by the computational operations 1112 to control components of the production operations. For example, production well and pipeline data can be analyzed to predict slugging in pipelines leading to a refinery and the computational operations 1112 can control machine operated valves upstream of the refinery to reduce the likelihood of plant disruptions that run the risk of taking the plant offline.

In some implementations of the computational operations 1112, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 12 is a block diagram of an example data processing system 1200 used to provide computational functionalities associated with described algorithms, methods, functions, processes, flows, and procedures described in the present disclosure. For example, the data processing system 1200 can be configured for 3D directional fault detection in post-stack seismic data using gradient phase transform in the frequency domain. The data processing device 1202 can include input devices such as keypads, keyboards, and touch screens that can accept user information. Also, the data processing device 1202 can include output devices that can convey information associated with the operation of the data processing device 1202. The information can include digital data, visual data, audio information, or a combination of information. The information can be presented in a graphical user interface (UI) (or GUI).

The data processing device 1202 can serve in a role as a client, a network component, a server, a database, a persistency, or components of a computer system for performing the subject matter described in the present disclosure. The illustrated data processing device 1202 is communicably coupled with a network 1224. In some implementations, one or more components of the data processing device 1202 can be configured to operate within different environments, including cloud-computing-based environments, local environments, global environments, and combinations of environments.

The data processing device 1202 can receive requests over network 1224 from a client application (for example, executing on another data processing device 1202). The data processing device 1202 can respond to the received requests by processing the received requests using software applications. Requests can also be sent to the data processing device 1202 from internal users (for example, from a command console), external (or third) parties, automated applications, entities, individuals, systems, and computers.

Each of the components of the data processing device 1202 can communicate using a system bus 1204. In some implementations, any, or all of the components of the data processing device 1202, including hardware or software components, can interface with each other or the interface 1206 (or a combination of both), over the system bus 1204. Interfaces can use an application programming interface (API) 1214, a service layer 1216, or a combination of the API 1214 and service layer 1216. The API 1214 can include specifications for routines, data structures, and object classes. The API 1214 can be either computer-language independent or dependent. The API 1214 can refer to a complete interface, a single function, or a set of A Pls.

The service layer 1216 can provide software services to the data processing device 1202 and other components (whether illustrated or not) that are communicably coupled to the data processing device 1202. The functionality of the data processing device 1202 can be accessible for all service consumers using this service layer. Software services, such as those provided by the service layer 1216, can provide reusable, defined functionalities through a defined interface. For example, the interface can be software written in JAVA, C++, or a language providing data in extensible markup language (XML) format. While illustrated as an integrated component of the data processing device 1202, in alternative implementations, the API 1214 or the service layer 1216 can be stand-alone components in relation to other components of the data processing device 1202 and other components communicably coupled to the data processing device 1202. Moreover, any or all parts of the API 1214 or the service layer 1216 can be implemented as child or sub-modules of another software module, enterprise application, or hardware module without departing from the scope of the present disclosure.

The data processing device 1202 includes an interface 1206. Although illustrated as a single interface 1206 in FIG. 12, two or more interfaces 1206 can be used according to implementations of the data processing device 1202 and the described functionality. The interface 1206 can be used by the data processing device 1202 for communicating with other systems that are connected to the network 1224 (whether illustrated or not) in a distributed environment. Generally, the interface 1206 can include, or be implemented using, logic encoded in software or hardware (or a combination of software and hardware) operable to communicate with the network 1224. More specifically, the interface 1206 can include software supporting one or more communication protocols associated with communications. As such, the network 1224 or the interface's hardware can be operable to communicate physical signals within and outside of the illustrated data processing device 1202.

The data processing device 1202 includes a processor 1208. Although illustrated as a single processor 1208 in FIG. 12, two or more processors 1208 can be used according to implementations of the data processing device 1202 and the described functionality. Generally, the processor 1208 can execute instructions and can manipulate data to perform the operations of the data processing device 1202, including operations using algorithms, methods, functions, processes, flows, and procedures as described in the present disclosure.

The data processing device 1202 also includes a database 1220 that can hold data (such as seismic data 1222) for the data processing device 1202 and other components connected to the network 1224 (whether illustrated or not). For example, database 1220 can be in-memory or a database storing data consistent with the present disclosure. In some implementations, database 1220 can be a combination of two or more different database types (for example, hybrid in-memory and conventional databases) according to implementations of the data processing device 1202 and the described functionality. While database 1220 is illustrated as an internal component of the data processing device 1202, in alternative implementations, database 1220 can be external to the data processing device 1202.

The data processing device 1202 also includes a memory 1210 that can hold data for the data processing device 1202 or a combination of components connected to the network 1224 (whether illustrated or not). In some implementations, memory 1210 can be a combination of two or more different types of memory (for example, a combination of semiconductor and magnetic storage) according to implementations of the data processing device 1202 and the described functionality. While memory 1210 is illustrated as an internal component of the data processing device 1202, in alternative implementations, memory 1210 can be external to the data processing device 1202.

The application 1212 can be an algorithmic software engine providing functionality according to implementations of the data processing device 1202 and the described functionality. For example, application 1212 can serve as one or more components, modules, or applications.

The data processing device 1202 can also include a power supply 1218. The power supply 1218 can include a rechargeable or non-rechargeable battery that can be configured to be either user- or non-user-replaceable.

There can be any number of computers 1202 associated with, or external to, a computer system including the data processing device 1202, with each data processing device 1202 communicating over network 1224. Further, the terms “client,” “user,” and other appropriate terminology can be used interchangeably, as appropriate, without departing from the scope of the present disclosure. Moreover, the present disclosure contemplates that many users can use one data processing device 1202 and one user can use multiple computers 1202.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (A SIC). In some implementations, the data processing apparatus or special purpose logic circuitry (or a combination of the data processing apparatus or special purpose logic circuitry) can be hardware- or software-based (or a combination of both hardware- and software-based).

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

### Embodiment/Examples

According to some non-limiting embodiments or examples, provided is a method for three dimensional directional fault detection in post-stack seismic data. The method includes dividing the post-stack seismic data into inline, crossline, and timeline data slices, where edges are detected in respective data slices by parallel processing. Dip angles representing faults are determined in a data slice by forming bins across a 360 degree range of orientations for the data slice in response to unknown dip angles. The data slice is decomposed into a frequency domain with multiple sub-bands representing a specific range of spatial frequencies, where each sub-band captures features at different scales. A phase filter is applied to modify a phase of the data slice in the frequency domain to enhance a contrast of edges, and a smoothening filter is applied to remove noise artifacts from the data slice in the frequency domain, where the phase filter is applied according to determined dip angles or known dip angles. A gradient field of the phase is extracted to detect edges present in the data slice in the frequency domain. The detected edges are transformed to generate an edge map corresponding to the data slice. Edge maps corresponding to inline, crossline, and timeline data slices are merged, and a subsurface is interpreted based on the merged edge maps.

According to some non-limiting embodiments or examples, provided is an apparatus including a non-transitory, computer readable, storage medium that stores instructions that, when executed by at least one processor, cause the at least one processor to perform operations including: determining dip angles representing faults in a data slice by forming bins across a 360 degree range of orientations for the data slice in response to unknown dip angles; decomposing the data slice into a frequency domain with multiple sub-bands representing a specific range of spatial frequencies, where each sub-band captures features at different scales; applying a phase filter to modify a phase of the data slice in the frequency domain to enhance a contrast of edges and a smoothening filter to remove noise artifacts from the data slice in the frequency domain, where the phase filter is applied according to determined dip angles or known dip angles; extracting a gradient field of the phase to detect edges present in the data slice in the frequency domain; transforming the detected edges to generate an edge map corresponding to the data slice; merging edge maps corresponding to inline, crossline, and timeline data slices; interpreting a subsurface data based on the merged edge maps.

According to some non-limiting embodiments or examples, provided is a system, including one or more memory modules and one or more hardware processors communicably coupled to the one or more memory modules. The one or more hardware processors is configured to execute instructions stored on the one or more memory modules to perform operations including: determining dip angles representing faults in a data slice by forming bins across a 360 degree range of orientations for the data slice in response to unknown dip angles; decomposing the data slice into a frequency domain with multiple sub-bands representing a specific range of spatial frequencies, where each sub-band captures features at different scales; applying a phase filter to modify a phase of the data slice in the frequency domain to enhance a contrast of edges and a smoothening filter to remove noise artifacts from the data slice in the frequency domain, where the phase filter is applied according to determined dip angles or known dip angles; extracting a gradient field of the phase to detect edges present in the data slice in the frequency domain; transforming the detected edges to generate an edge map corresponding to the data slice; merging edge maps corresponding to inline, crossline, and timeline data slices; and interpreting a subsurface based on the merged edge maps.

Further non-limiting aspects or embodiments are set forth in the following numbered embodiments:

Embodiment 1: A method for three dimensional directional fault detection in post-stack seismic data, including: dividing the post-stack seismic data into inline, crossline, and timeline data slices, where edges are detected in respective data slices by parallel processing including: determining dip angles representing faults in a data slice by forming bins across a 360 degree range of orientations for the data slice in response to unknown dip angles; decomposing the data slice into a frequency domain with multiple sub-bands representing a specific range of spatial frequencies, where each sub-band captures features at different scales; applying a phase filter to modify a phase of the data slice in the frequency domain to enhance a contrast of edges and a smoothening filter to remove noise artifacts from the data slice in the frequency domain, where the phase filter is applied according to determined dip angles or known dip angles; extracting a gradient field of the phase to detect edges present in the data slice in the frequency domain; transforming the detected edges to generate an edge map corresponding to the data slice; merging edge maps corresponding to inline, crossline, and timeline data slices; and interpreting a subsurface based on the merged edge maps.

Embodiment 2: The method of any preceding embodiments, where the known dip angles are specified by a user to focus the phase filter and gradient field extraction to detect edges of a target fault.

Embodiment 3: The method of any preceding embodiments, including applying seismic data conditioning to the data slice in the frequency domain.

Embodiment 4: The method of any preceding embodiments, where applying the phase filter to modify a phase of the data slice includes using the determined dip angles or known dip angles as a steerable angle variable θ of the phase filter.

Embodiment 5: The method of any preceding embodiments, where extracting a gradient field of the phase to detect edges includes computing the gradient of the phase to determine areas of the data slice where a brightness of the data slice changes abruptly.

Embodiment 6: The method of any preceding embodiments, where a three dimensional volume viewable by directions is created by merging edge maps corresponding to inline, crossline, and timeline data slices.

Embodiment 7: The method of any preceding embodiments, where transforming the detected edges to generate an edge map corresponding to the data slice includes applying an inverse Fourier transform to the modified phase and extracted gradient field to convert the detected edges to a spatial domain.

Embodiment 8: The method of any preceding embodiments, where the merged edge maps are super-imposed on an image corresponding to the post-stack seismic data.

Embodiment 9: An apparatus including a non-transitory, computer readable, storage medium that stores instructions that, when executed by at least one processor, cause the at least one processor to perform operations including: determining dip angles representing faults in a data slice by forming bins across a 360 degree range of orientations for the data slice in response to unknown dip angles; decomposing the data slice into a frequency domain with multiple sub-bands representing a specific range of spatial frequencies, where each sub-band captures features at different scales; applying a phase filter to modify a phase of the data slice in the frequency domain to enhance a contrast of edges and a smoothening filter to remove noise artifacts from the data slice in the frequency domain, where the phase filter is applied according to determined dip angles or known dip angles; extracting a gradient field of the phase to detect edges present in the data slice in the frequency domain; transforming the detected edges to generate an edge map corresponding to the data slice; merging edge maps corresponding to inline, crossline, and timeline data slices; and interpreting a subsurface data based on the merged edge maps.

Embodiment 10. The apparatus of any preceding embodiments, where the known dip angles are specified by a user to focus the phase filter and gradient field extraction to detect edges of a target fault.

Embodiment 11: The apparatus of any preceding embodiments, including applying seismic data conditioning to the data slice in the frequency domain.

Embodiment 12: The apparatus of any preceding embodiments, where applying the phase filter to modify a phase of the data slice includes using the determined dip angles or known dip angles as a steerable angle variable θ of the phase filter.

Embodiment 13: The apparatus of any preceding embodiments, where extracting a gradient field of the phase to detect edges includes computing the gradient of the phase to determine areas of the data slice where a brightness of the data slice changes abruptly.

Embodiment 14: The apparatus of any preceding embodiments, where a three dimensional volume viewable by directions is created by merging edge maps corresponding to inline, crossline, and timeline data slices.

Embodiment 15: The apparatus of any preceding embodiments, where

transforming the detected edges to generate an edge map corresponding to the data slice includes applying an inverse Fourier transform to the modified phase and extracted gradient field to convert the detected edges to a spatial domain.

Embodiment 16: The apparatus of any preceding embodiments, where the merged edge maps are super-imposed on an image corresponding to post-stack seismic data.

Embodiment 17: A system, including: one or more memory modules; one or more hardware processors communicably coupled to the one or more memory modules, the one or more hardware processors configured to execute instructions stored on the one or more memory modules to perform operations including: determining dip angles representing faults in a data slice by forming bins across a 360 degree range of orientations for the data slice in response to unknown dip angles; decomposing the data slice into a frequency domain with multiple sub-bands representing a specific range of spatial frequencies, where each sub-band captures features at different scales; applying a phase filter to modify a phase of the data slice in the frequency domain to enhance a contrast of edges and a smoothening filter to remove noise artifacts from the data slice in the frequency domain, where the phase filter is applied according to determined dip angles or known dip angles; extracting a gradient field of the phase to detect edges present in the data slice in the frequency domain; transforming the detected edges to generate an edge map corresponding to the data slice; merging edge maps corresponding to inline, crossline, and timeline data slices; and interpreting a subsurface based on the merged edge maps.

Embodiment 18: The system of any preceding embodiments, where the known dip angles are specified by a user to focus the phase filter and gradient field extraction to detect edges of a target fault.

Embodiment 19: The system of any preceding embodiments, including applying seismic data conditioning to the data slice in the frequency domain.

Embodiment 20: The system of any preceding embodiments, where applying the phase filter to modify a phase of the data slice includes using the determined dip angles or known dip angles as a steerable angle variable θ of the phase filter.

A number of embodiments of the systems and methods have been described. Nevertheless, it will be understood that various modifications may be made without departing from the spirit and scope of this specification. Accordingly, other embodiments are within the scope of the following claims.

What is claimed is:

1. A method for three dimensional directional fault detection in post-stack seismic data, comprising:
dividing the post-stack seismic data into inline, crossline, and timeline data slices, wherein edges are detected in respective data slices by parallel processing comprising:
determining dip angles representing faults in a data slice by forming bins across a 360 degree range of orientations for the data slice in response to unknown dip angles;
decomposing the data slice into a frequency domain with multiple sub-bands representing a specific range of spatial frequencies, where each sub-band captures features at different scales;
applying a phase filter to modify a phase of the data slice in the frequency domain to enhance a contrast of edges and a smoothening filter to remove noise artifacts from the data slice in the frequency domain, wherein the phase filter is applied according to determined dip angles or known dip angles;
extracting a gradient field of the phase to detect edges present in the data slice in the frequency domain;
transforming the detected edges to generate an edge map corresponding to the data slice;
merging edge maps corresponding to inline, crossline, and timeline data slices; and
interpreting a subsurface corresponding to the respective data slices based on the merged edge maps.

2. The method of claim 1, wherein the known dip angles are specified by a user to focus the phase filter and gradient field extraction to detect edges of a target fault.

3. The method of claim 1, comprising applying seismic data conditioning to the data slice in the frequency domain.

4. The method of claim 1, wherein applying the phase filter to modify a phase of the data slice comprises using the determined dip angles or known dip angles as a steerable angle variable θ of the phase filter.

5. The method of claim 1, wherein extracting a gradient field of the phase to detect edges comprises computing the gradient of the phase to determine areas of the data slice where a brightness of the data slice changes abruptly.

6. The method of claim 1, wherein a three dimensional volume viewable by directions is created by merging edge maps corresponding to inline, crossline, and timeline data slices.

7. The method of claim 1, wherein transforming the detected edges to generate an edge map corresponding to the data slice comprises applying an inverse Fourier transform to the modified phase and extracted gradient field to convert the detected edges to a spatial domain.

8. The method of claim 1, wherein the merged edge maps are super-imposed on an image corresponding to the post-stack seismic data.

9. An apparatus comprising a non-transitory, computer readable, storage medium that stores instructions that, when executed by at least one processor, cause the at least one processor to perform operations comprising:
determining dip angles representing faults in a data slice by forming bins across a 360 degree range of orientations for the data slice in response to unknown dip angles;
decomposing the data slice into a frequency domain with multiple sub-bands representing a specific range of spatial frequencies, where each sub-band captures features at different scales;
applying a phase filter to modify a phase of the data slice in the frequency domain to enhance a contrast of edges and a smoothening filter to remove noise artifacts from the data slice in the frequency domain, wherein the phase filter is applied according to determined dip angles or known dip angles;
extracting a gradient field of the phase to detect edges present in the data slice in the frequency domain;
transforming the detected edges to generate an edge map corresponding to the data slice;
merging edge maps corresponding to inline, crossline, and timeline data slices; and
interpreting a subsurface data based on the merged edge maps.

10. The apparatus of claim 9, wherein the known dip angles are specified by a user to focus the phase filter and gradient field extraction to detect edges of a target fault.

11. The apparatus of claim 9, comprising applying seismic data conditioning to the data slice in the frequency domain.

12. The apparatus of claim 9, wherein applying the phase filter to modify a phase of the data slice comprises using the determined dip angles or known dip angles as a steerable angle variable θ of the phase filter.

13. The apparatus of claim 9, wherein extracting a gradient field of the phase to detect edges comprises computing the gradient of the phase to determine areas of the data slice where a brightness of the data slice changes abruptly.

14. The apparatus of claim 9, wherein a three dimensional volume viewable by directions is created by merging edge maps corresponding to inline, crossline, and timeline data slices.

15. The apparatus of claim 9, wherein transforming the detected edges to generate an edge map corresponding to the data slice comprises applying an inverse Fourier transform to the modified phase and extracted gradient field to convert the detected edges to a spatial domain.

16. The apparatus of claim 9, wherein the merged edge maps are super-imposed on an image corresponding to post-stack seismic data.

17. A system, comprising:
one or more memory modules;
one or more hardware processors communicably coupled to the one or more memory modules, the one or more hardware processors configured to execute instructions stored on the one or more memory modules to perform operations comprising:
determining dip angles representing faults in a data slice by forming bins across a 360 degree range of orientations for the data slice in response to unknown dip angles;
decomposing the data slice into a frequency domain with multiple sub-bands representing a specific range of spatial frequencies, where each sub-band captures features at different scales;
applying a phase filter to modify a phase of the data slice in the frequency domain to enhance a contrast of edges and a smoothening filter to remove noise artifacts from the data slice in the frequency domain, wherein the phase filter is applied according to determined dip angles or known dip angles;
extracting a gradient field of the phase to detect edges present in the data slice in the frequency domain;
transforming the detected edges to generate an edge map corresponding to the data slice;
merging edge maps corresponding to inline, crossline, and timeline data slices; and
interpreting a subsurface based on the merged edge maps.

18. The system of claim 17, wherein the known dip angles are specified by a user to focus the phase filter and gradient field extraction to detect edges of a target fault.

19. The system of claim 17, comprising applying seismic data conditioning to the data slice in the frequency domain.

20. The system of claim 17, wherein applying the phase filter to modify a phase of the data slice comprises using the determined dip angles or known dip angles as a steerable angle variable θ of the phase filter.
